(19) United States
(12) Patent Application Publication
(10) Pub. No.: US 2003/0085308 A1
(43) Pub. Date: May 8, 2003

(54) Two-piece flow-homogenizing fuel injection nozzle and system and method incorporating same

(76) Inventor: Scott E. Parrish, Farmington Hills, MI (US)

Correspondence Address: Tait R. Swanson, Fletcher, Yoder & Van Someren, P.O. Box 692289, Houston, TX, 77269-2289, US

(21) Appl. No.: 10/005,671

(22) Filed: Nov. 8, 2001

(51) Int. Cl. F02M 51/00

(52) U.S. Cl. 239/585.1

(57) ABSTRACT

A technique is provided for homogenizing fluid flow in a nozzle assembly, which has an outwardly opening poppet disposed in a conduit. A fluid passage is provided independently from the conduit to supply fluid to a forward portion of the conduit adjacent a spray formation exit. The fluid passage has a desired geometry configured to facilitate fluid flow homogenization through the nozzle assembly. Accordingly, the spray produced at the spray formation exit has a substantially uniform distribution of fluid droplets.

### BACKGROUND OF THE INVENTION

1. Field of the Invention

The present invention relates generally to the field of internal combustion engine injection systems. More particularly, the invention relates to a technique for homogenizing fluid flow through a spray assembly and for providing a relatively uniform spray pattern by providing relatively large fluid passageways leading to the exit of the spray assembly.

2. Description of the Related Art

In fuel-injected engines, it is generally considered desirable that each injector delivers approximately the same quantity of fuel in approximately the same temporal relationship to the engine for proper operation. It is also well known that the fuel-air mixture affects the combustion process and the formation of pollutants, such as Sulfur Oxides, Nitrogen Oxides, Hydrocarbons, and particulate matter. Although combustion engines utilize a variety of mixing techniques to improve the fuel-air mixture, many combustion engines rely heavily on spray assemblies to disperse fuel throughout a combustion chamber. These spray assemblies may produce a variety of spray patterns, such as a hollow or solid conical spray pattern, which affect the overall fuel-air mixture in the combustion chamber. It is generally desirable to provide a uniform fuel-air mixture to optimize the combustion process and to eliminate pollutants. However, conventional combustion engines continue to operate inefficiently and produce pollutants due to poor fuel-air mixing in the combustion chamber.

Accordingly, the present technique provides various unique features to overcome the disadvantages of existing spray systems and to improve the fuel-air mixture in combustion engines. In particular, unique features are provided to enhance the fluid flow through an outwardly opening nozzle assembly to provide desired spray characteristics.

### SUMMARY OF THE INVENTION

The present technique offers a design for internal combustion engines that contemplates such needs. The technique is applicable to a variety of fuel injection systems, and is particularly well suited to pressure pulsed designs, in which fuel is pressurized for injection into a combustion chamber by a reciprocating electric motor and pump. However, other injection system types may benefit from the technique described herein, including those in which fuel and air are admitted into a combustion chamber in mixture. Accordingly, a technique is provided for homogenizing fluid flow in a nozzle assembly, which has an outwardly opening poppet disposed in a conduit. A fluid passage is provided independently from the conduit to supply fluid to a forward portion of the conduit adjacent a spray formation exit. The fluid passage has a desired geometry configured to facilitate fluid flow homogenization through the nozzle assembly. Accordingly, the spray produced at the spray formation exit has a substantially uniform distribution of fluid droplets.

In one aspect, the present technique provides a nozzle comprising a nozzle body having an outwardly opening poppet. The nozzle has a central passage extending through the nozzle body. The nozzle also has a flow passage disposed about the central passage and terminating at a forward portion of the central passage. The outwardly opening poppet is movably disposed in the central passage. In this embodiment, the outwardly opening poppet is configured for controlling fluid flow through the flow passage and out through the forward portion to form a spray.

In another aspect, the present technique provides a method for producing a spray. The method comprises moving an outwardly opening poppet within a central passage of a nozzle housing. In this embodiment, fluid is provided to a forward portion of the central passage through a separate passage having a geometry configured to facilitate fluid flow homogenization.

### BRIEF DESCRIPTION OF THE DRAWINGS

The foregoing and other advantages of the invention will become apparent upon reading the following detailed description and upon reference to the drawings in which:

FIG. 1 is a side view of a marine propulsion device embodying an outboard drive or propulsion unit adapted for mounting to a transom of a watercraft;

FIG. 2 is a cross-sectional view of the combustion engine;

FIG. 3 is a diagrammatical representation of a series of fluid pump assemblies applied to inject fuel into an internal combustion engine;

FIG. 4 is a partial cross-sectional view of an exemplary pump in accordance with aspects of the present technique for use in displacing fluid under pressure, such as for fuel injection into a chamber of an internal combustion engine as shown in FIG. 3;

FIG. 5 is a partial cross-sectional view of the pump illustrated in FIG. 4 energized to an open position during a pumping phase of operation;

FIG. 6 is a partial cross-sectional view of an exemplary nozzle assembly in a closed position, as illustrated in FIG. 4;

FIG. 7 is a partial cross-sectional view of the nozzle assembly in the open position, as illustrated in FIG. 5;

FIG. 8 is a cross-sectional view of an exemplary hollow spray formed by the nozzle assembly illustrated in FIG. 7; and

FIG. 9 is a cross-sectional view of the hollow spray illustrated in FIG. 8.

### DETAILED DESCRIPTION OF SPECIFIC EMBODIMENTS

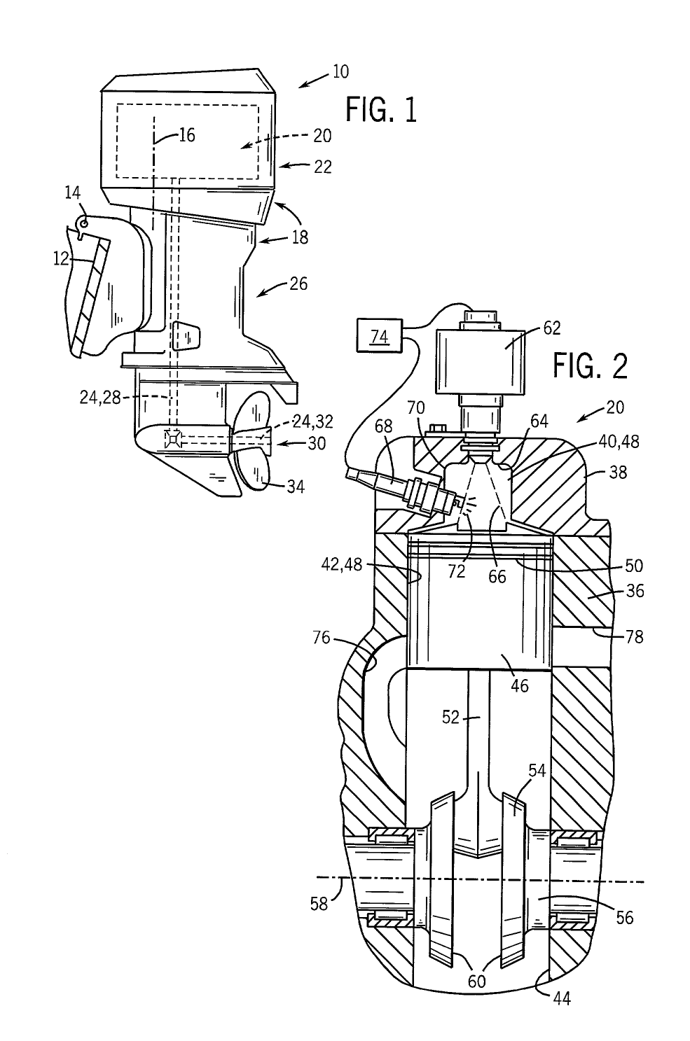

The present technique will be described with respect to a 2-cycle outboard marine engine as illustrated in FIGS. 1-2. However, it will be appreciated that this invention is equally applicable for use with a 4-cycle engine, a diesel engine, or any other type of internal combustion engine having at least one fuel injector, which may have one or more geometrically varying fluid passageways leading to a nozzle exit. The present technique is also applicable in other applications utilizing fluid spray assemblies, such as a nozzle producing a hollow or solid cone-shaped droplet spray.

FIG. 1 is a side view of a marine propulsion device embodying an outboard drive or propulsion unit 10 adapted to be mounted on a transom 12 of a watercraft for pivotal tilting movement about a generally horizontal tilt axis 14 and for pivotal steering movement about a generally upright steering axis 16. The drive or propulsion unit 10 has a housing 18, wherein a fuel-injected, two-stroke internal combustion engine 20 is disposed in an upper section 22 and a transmission assembly 24 is disposed in a lower section 26. The transmission assembly 24 has a drive shaft 28 drivingly coupled to the combustion engine 20, and extending longitudinally through the lower section 26 to a propulsion region 30 whereat the drive shaft 28 is drivingly coupled to a propeller shaft 32. Finally, the propeller shaft 32 is drivingly coupled to a prop 34 for rotating the prop 34, thereby creating a thrust force in a body of water. In the present technique, the combustion engine 20 may embody a four-cylinder or six-cylinder V-type engine for marine applications, or it may embody a variety of other combustion engines with a suitable design for a desired application, such as automotive, industrial, etc.

FIG. 2 is a cross-sectional view of the combustion engine 20. For illustration purposes, the combustion engine 20 is illustrated as a two-stroke, direct-injected, internal combustion engine having a single piston and cylinder. As illustrated, the combustion engine 20 has an engine block 36 and a head 38 coupled together and defining a firing chamber 40 in the head 38, a piston cylinder 42 in the engine block 36 adjacent to the firing chamber 40, and a crankcase chamber 44 in the engine block 36 adjacent to the piston cylinder 42. A piston 46 is slidably disposed in the piston cylinder 42, and defines a combustion chamber 48 adjacent to the firing chamber 40. A ring 50 is disposed about the piston 46 for providing a sealing force between the piston 46 and the piston cylinder 42. A connecting rod 52 is pivotally coupled to the piston 46 on a side opposite from the combustion chamber 48, and the connecting rod 52 is also pivotally coupled to an outer portion 54 of a crankshaft 56 for rotating the crankshaft 56 about an axis 58. The crankshaft 56 is rotatably coupled to the crankcase chamber 44, and preferably has counterweights 60 opposite from the outer portion 54 with respect to the axis 58.

In general, an internal combustion engine such as engine 20 operates by compressing and igniting a fuel-air mixture. In some combustion engines, fuel is injected into an air intake manifold, and then the fuel-air mixture is injected into the firing chamber for compression and ignition. As described below, the illustrated embodiment intakes only the air, followed by direct fuel injection and then ignition in the firing chamber.

A fuel injection system, having a fuel injector 62 disposed in a first portion 64 of the head 38, is provided for directly injecting a fuel spray 66 into the firing chamber 40. An ignition assembly, having a spark plug 68 disposed in a second portion 70 of the head 38, is provided for creating a spark 72 to ignite the fuel-air mixture compressed within the firing chamber 40. As discussed in further detail, the control and timing of the fuel injector 62 and the spark plug 68 are critical to the performance of the combustion engine 20. Accordingly, the fuel injection system and the ignition assembly are coupled to a control assembly 74. The uniformity of the fuel spray 66 is also critical to performance of the combustion engine 20. The distribution of fuel spray 66 affects the combustion process, the formation of pollutants and various other factors.

In operation, the piston 46 linearly moves between a bottom dead center position (not illustrated) and a top dead center position (as illustrated in FIG. 2), thereby rotating the crankshaft 56 in the process of the linear movement. At bottom dead center, an intake passage 76 couples the combustion chamber 48 to the crankcase chamber 44, allowing air to flow from the crankcase chamber 44 below the piston 46 to the combustion chamber 48 above the piston 46. The piston 46 then moves linearly upward from bottom dead center to top dead center, thereby closing the intake passage 76 and compressing the air into the firing chamber 40. At some point, determined by the control assembly 74, the fuel injection system is engaged to trigger the fuel injector 62, and the ignition assembly is engaged to trigger the spark plug 68. Accordingly, the fuel-air mixture combusts and expands from the firing chamber 40 into the combustion chamber 48, and the piston 46 is forced downwardly toward bottom dead center. This downward motion is conveyed to the crankshaft 56 by the connecting rod 52 to produce a rotational motion of the crankshaft 56, which is then conveyed to the prop 34 by the transmission assembly 24 (as illustrated in FIG. 1). Near bottom dead center, the combusted fuel-air mixture is exhausted from the piston cylinder 42 through an exhaust passage 78. The combustion process then repeats itself as the cylinder is charged by air through the intake passage 76.

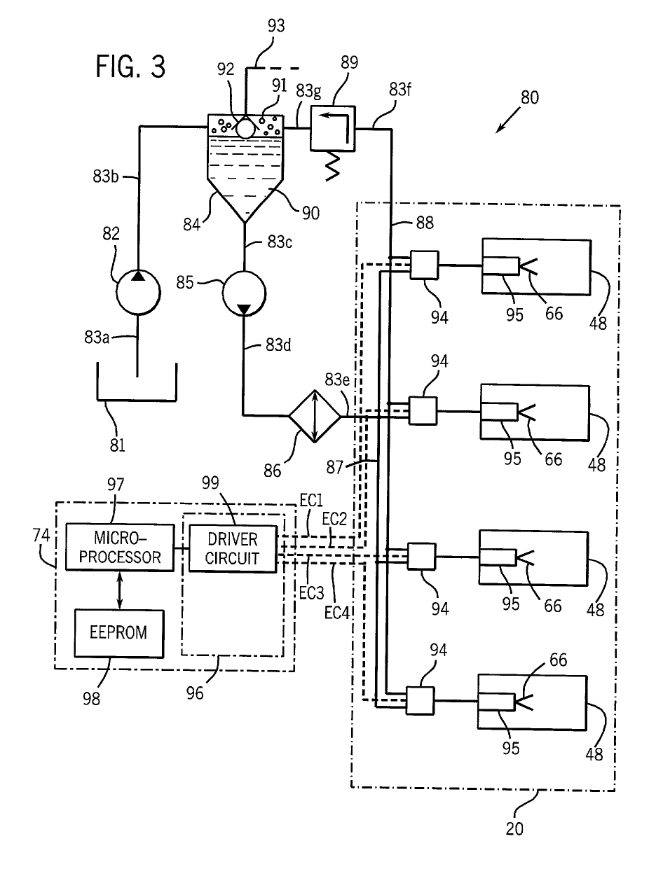

Referring now to FIG. 3, the fuel injection system 80 is diagrammatically illustrated as having a series of pumps for displacing fuel under pressure in the internal combustion engine 20. While the fluid pumps of the present technique may be employed in a wide variety of settings, they are particularly well suited to fuel injection systems in which relatively small quantities of fuel are pressurized cyclically to inject the fuel into combustion chambers of an engine as a function of the engine demands. The pumps may be employed with individual combustion chambers as in the illustrated embodiment, or may be associated in various ways to pressurize quantities of fuel, as in a fuel rail, feed manifold, and so forth. Even more generally, the present pumping technique may be employed in settings other than fuel injection, such as for displacing fluids under pressure in response to electrical control signals used to energize coils of a drive assembly, as described below. Moreover, the system 80 and engine 20 may be used in any appropriate setting, and are particularly well suited to two-stroke applications such as marine propulsion, outboard motors, motorcycles, scooters, snowmobiles and other vehicles.

In the exemplary embodiment shown in FIG. 3, the fuel injection system 80 has a fuel reservoir 81, such as a tank for containing a reserve of liquid fuel. A first pump 82 draws the fuel from the reservoir 81 through a first fuel line 83a, and delivers the fuel through a second fuel line 83b to a separator 84. While the system may function adequately without a separator 84, in the illustrated embodiment, separator 84 serves to insure that the fuel injection system downstream receives liquid fuel, as opposed to mixed phase fuel. A second pump 85 draws the liquid fuel from separator 84 through a third fuel line 83c and delivers the fuel, through a fourth fuel line 83d and further through a cooler 86, to a feed or inlet manifold 87 through a fifth fuel line 83e. Cooler 86 may be any suitable type of fluid cooler, including both air and liquid heater exchangers, radiators, and the like.

Fuel from the feed manifold 87 is available for injection into combustion chambers of engine 20, as described more fully below. A return manifold 88 is provided for recirculating fluid not injected into the combustion chambers of the engine. In the illustrated embodiment a pressure regulating valve 89 is coupled to the return manifold 88 through a sixth fuel line 83f and is used for maintaining a desired pressure within the return manifold 88. Fluid returned via the pressure regulating valve 89 is recirculated into the separator 84 through a seventh fuel line 83g where the fuel collects in liquid phase as illustrated at reference numeral 90. Gaseous phase components of the fuel, designated by referenced numeral 91 in FIG. 3, may rise from the fuel surface and, depending upon the level of liquid fuel within the separator, may be allowed to escape via a float valve 92. The float valve 92 consists of a float that operates a ventilation valve coupled to a ventilation line 93. The ventilation line 93 is provided for permitting the escape of gaseous components, such as for repressurization, recirculation, and so forth. The float rides on the liquid fuel 90 in the separator 84 and regulates the ventilation valve based on the level of the liquid fuel 90 and the presence of vapor in the separator 84.

As illustrated in FIG. 3, engine 20 may include a series of combustion chambers 48 for collectively driving the crankshaft 56 in rotation. As discussed with reference to FIG. 2, the combustion chambers 48 comprise the space adjacent to a series of pistons 46 disposed in piston cylinders 42. As will be appreciated by those skilled in the art, and depending upon the engine design, the pistons 46 (FIG. 2) are driven in a reciprocating fashion within each piston cylinder 42 in response to ignition, combustion and expansion of the fuel-air mixture within each combustion chamber 48. The stroke of the piston within the chamber will permit fresh air for subsequent combustion cycles to be admitted into the chamber, while scavenging combustion products from the chamber. While the present embodiment employs a straightforward two-stroke engine design, the pumps in accordance with the present technique may be adapted for a wide variety of applications and engine designs, including other than two-stroke engines and cycles.

In the illustrated embodiment, the fuel injection system 80 has a reciprocating pump 94 associated with each combustion chamber 48, each pump 94 drawing pressurized fuel from the feed manifold 87, and further pressurizing the fuel for injection into the respective combustion chamber 48. In this exemplary embodiment, the fuel injector 62 (FIG. 2) may have a nozzle 95 (FIG. 3) for atomizing the pressurized fuel downstream of each reciprocating pump 94. While the present technique is not intended to be limited to any particular injection system or injection scheme, in the illustrated embodiment, a pressure pulse created in the liquid fuel forces the fuel spray 66 to be formed at the mouth or outlet of the nozzle 95, for direct, in-cylinder injection. The operation of reciprocating pumps 94 is controlled by an injection controller 96 of the control assembly 74. The injection controller 96, which will typically include a programmed microprocessor or other digital processing circuitry and memory for storing a routine employed in providing control signals to the pumps, applies energizing signals to the pumps to cause their reciprocation in any one of a wide variety of manners as described more fully below.

The control assembly 74 and/or the injection controller 96 may have a processor 97 or other digital processing circuitry, a memory device 98 such as EEPROM for storing a routine employed in providing command signals from the processor 97, and a driver circuit 99 for processing commands or signals from the processor 97. The control assembly 74 and the injection controller 96 may utilize the same processor 97 and memory as illustrated in FIG. 3, or the injection controller 96 may have a separate processor and memory device. The driver circuit 99 may be constructed with multiple circuits or channels, each individual channel corresponding with a reciprocating pump 94. In operation, a command signal may be passed from the processor 97 to the driver circuit 99, which responds by generating separate drive signals for each channel. These signals are carried to each individual pump 94 as represented by individual electric connections EC1, EC2, EC3 and EC4. Each of these connections corresponds with a channel of the driver circuit 99. The operation and logic of the control assembly 74 and injection controller 96 will be discussed in greater detail below.

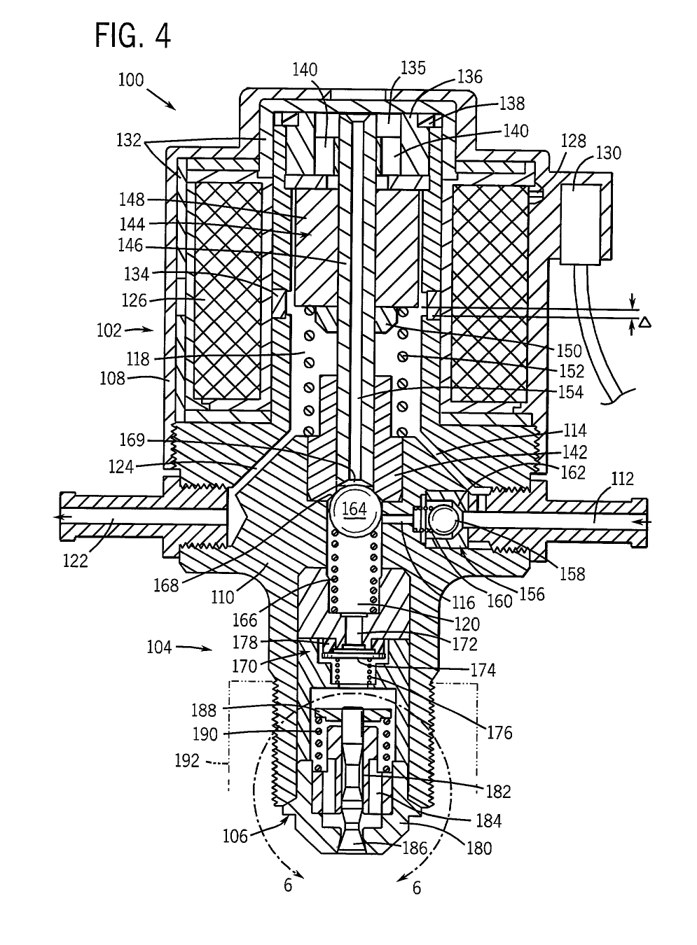

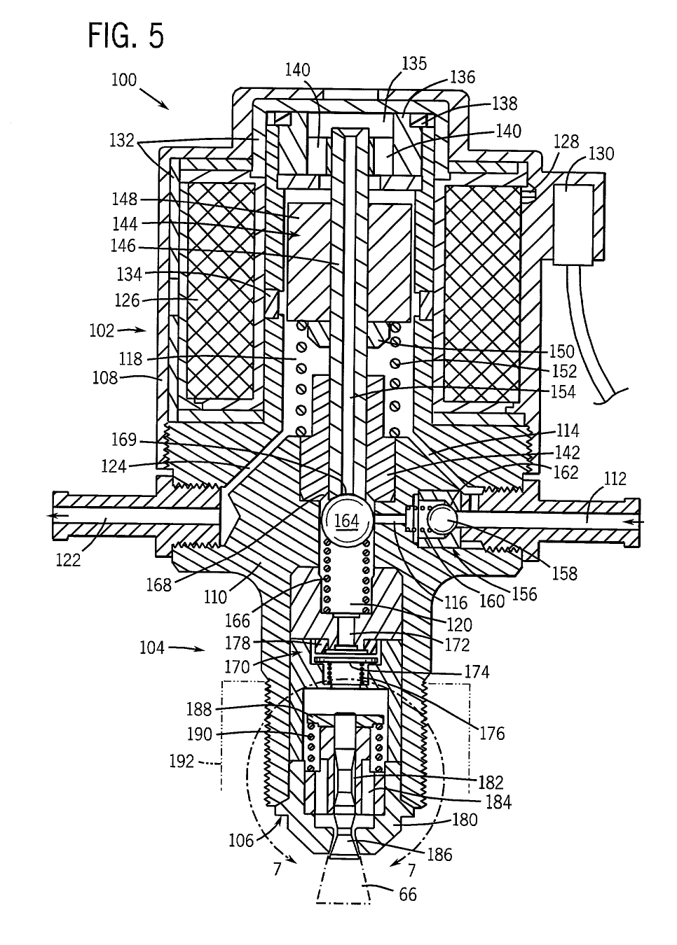

Specifically, FIG. 4 illustrates the internal components of a pump assembly including a drive section and a pumping section in a first position wherein fuel is introduced into the pump for pressurization. FIG. 5 illustrates the same pump following energization of a solenoid coil to drive a reciprocating assembly and thus cause pressurization of the fuel and its expulsion from the pump. It should be borne in mind that the particular configurations illustrated in FIGS. 4 and 5 are intended to be exemplary only. Other variations on the pump may be envisaged, particularly variants on the components used to pressurize the fluid and to deliver the fluid to a downstream application.

In the presently contemplated embodiment, a pump and nozzle assembly 100, as illustrated in FIGS. 4 and 5, is particularly well suited for application in an internal combustion engine, as illustrated in FIGS. 1-3. Moreover, in the embodiment illustrated in FIGS. 4 and 5, a nozzle assembly is installed directly at an outlet of a pump section, such that the pump 94 and the nozzle 95 of FIG. 3 are incorporated into a single assembly 100. As indicated above, in appropriate applications, the pump 94 may be separated from the nozzle 95, such as for application of fluid under pressure to a manifold, fuel rail, or other downstream component. Thus, the fuel injector 62 described with reference to FIG. 2 may comprise the nozzle 95, the pump and nozzle assembly 100, or other designs and configurations capable of fuel injection.

Referring to FIG. 4, an embodiment is shown wherein the fluid actuators and fuel injectors are combined into a single unit, or pump-nozzle assembly 100. The pump-nozzle assembly 100 is composed of three primary subassemblies: a drive section 102, a pump section 104, and a nozzle 106. The drive section 102 is contained within a solenoid housing 108. A pump housing 110 serves as the base for the pump-nozzle assembly 100. The pump housing 110 is attached to the solenoid housing 108 at one end and to the nozzle 106 at an opposite end.

There are several flow paths for fuel within pump-nozzle assembly 100. Initially, fuel enters the pump-nozzle assembly 100 through the fuel inlet 112. Fuel can flow from the fuel inlet 112 through two flow passages, a first passageway 114 and a second passageway 116. A portion of fuel flows through the first passageway 114 into an armature chamber 118. For pumping, fuel also flows through the second passageway 116 to a pump chamber 120. Heat and vapor bubbles are carried from the armature chamber 118 by fuel flowing to an outlet 122 through a third fluid passageway 124. Fuel then flows from the outlet 122 to the return manifold 88 (see FIG. 3).

The drive section 102 incorporates a linear electric motor. In the illustrated embodiment, the linear electric motor is a reluctance gap device. In the present context, reluctance is the opposition of a magnetic circuit to the establishment or flow of a magnetic flux. A magnetic field and circuit are produced in the motor by electric current flowing through a coil 126. The coil 126 is electrically coupled by leads 128 to a receptacle 130, which is coupled by conductors (not shown) to an injection controller 96 of the control assembly 74. Magnetic flux flows in a magnetic circuit 132 around the exterior of the coil 126 when the coil is energized. The magnetic circuit 132 is composed of a material with a low reluctance, typically a magnetic material, such as ferromagnetic alloy, or other magnetically conductive materials. A gap in the magnetic circuit 132 is formed by a reluctance gap spacer 134 composed of a material with a relatively higher reluctance than the magnetic circuit 132, such as synthetic plastic.

A reciprocating assembly 144 forms the linear moving elements of the reluctance motor. The reciprocating assembly 144 includes a guide tube 146, an armature 148, a centering element 150 and a spring 152. The guide tube 146 is supported at the upper end of travel by the upper bushing 136 and at the lower end of travel by the lower bushing 142. An armature 148 is attached to the guide tube 146. The armature 148 sits atop a biasing spring 152 that opposes the downward motion of the armature 148 and guide tube 146, and maintains the guide tube and armature in an upwardly biased or retracted position. Centering element 150 keeps the spring 152 and armature 148 in proper centered alignment. The guide tube 146 has a central passageway 154, which permits the flow of a small volume of fuel when the guide tube 146 moves a given distance through the armature chamber 118 as described below. Accordingly, the flow of fuel through the central passageway 154 facilitates cooling and acceleration of the guide tube 146, which is moved in response to energizing the coil during operation.

When the coil 126 is energized, the magnetic flux field produced by the coil 126 seeks the path of least reluctance. The armature 148 and the magnetic circuit 132 are composed of a material of relatively low reluctance. The magnetic flux lines will thus extend around coil 126 and through magnetic circuit 132 until the magnetic gap spacer 134 is reached. The magnetic flux lines will then extend to armature 148 and an electromagnetic force will be produced to drive the armature 148 downward towards the reluctance gap spacer 134. When the flow of electric current is removed from the coil by the injection controller 96, the magnetic flux will collapse and the force of spring 152 will drive the armature 148 upwardly and away from alignment with the reluctance gap spacer 134. Cycling the electrical control signals provided to the coil 126 produces a reciprocating linear motion of the armature 148 and guide tube 146 by the upward force of the spring 152 and the downward force produced by the magnetic flux field on the armature 148.

During the return motion of the reciprocating assembly 144 a fluid brake within the pump-nozzle assembly 100 acts to slow the upward motion of the moving portions of the drive section 102. The upper portion of the solenoid housing 108 is shaped to form a recessed cavity 135. An upper bushing 136 separates the recessed cavity 135 from the armature chamber 118 and provides support for the moving elements of the drive section at the upper end of travel. A seal 138 is located between the upper bushing 136 and the solenoid housing 108 to ensure that the only flow of fuel from the armature chamber 118 to and from the recessed cavity 135 is through fluid passages 140 in the upper bushing 136. In operation, the moving portions of the drive section 102 will displace fuel from the armature chamber 118 into the recessed cavity 135 during the period of upward motion. The flow of fuel is restricted through the fluid passageways 140, thus, acting as a brake on upward motion. A lower bushing 142 is included to provide support for the moving elements of the drive section at the lower travel limit and to seal the pump section from the drive section.

While the first fuel flow path 114 provides proper dampening for the reciprocating assembly as well as providing heat transfer benefits, the second fuel flow path 116 provides the fuel for pumping and, ultimately, for combustion. The drive section 102 provides the motive force to drive the pump section 104, which produces a surge of pressure that forces fuel through the nozzle 106. As described above, the drive section 102 operates cyclically to produce a reciprocating linear motion in the guide tube 146. During a charging phase of the cycle, fuel is drawn into the pump section 104. Subsequently, during a discharging phase of the cycle, the pump section 104 pressurizes the fuel and discharges the fuel through the nozzle 106, such as directly into the combustion chamber 48 (see FIG. 3).

During the charging phase fuel enters the pump section 104 from the inlet 112 through an inlet check valve assembly 156. The inlet check valve assembly 156 contains a ball 158 biased by a spring 160 toward a seat 162. During the charging phase the pressure of the fuel in the fuel inlet 112 will overcome the spring force and unseat the ball 158. Fuel will flow around the ball 158 and through the second passageway 116 into the pump chamber 120. During the discharging phase the pressurized fuel in the pump chamber 120 will assist the spring 160 in seating the ball 158, preventing any reverse flow through the inlet check valve assembly 156.

A pressure surge is produced in the pump section 104 when the guide tube 146 drives a pump sealing member 164 into the pump chamber 120. The pump sealing member 164 is held in a biased position by a spring 166 against a stop 168. The force of the spring 166 opposes the motion of the pump sealing member 164 into the pump chamber 120. When the coil 126 is energized to drive the armature 148 towards alignment with the reluctance gap spacer 134, the guide tube 146 is driven towards the pump sealing member 164. There is, initially, a gap 169 between the guide tube 146 and the pump sealing member 164. Until the guide tube 146 transits the gap 169 there is essentially no increase in the fuel pressure within the pump chamber 120, and the guide tube and armature are free to gain momentum by flow of fuel through passageway 154. The acceleration of the guide tube 146 as it transits the gap 169 produces the rapid initial surge in fuel pressure once the guide tube 146 contacts the pump sealing member 164, which seals passageway 154 to pressurize the volume of fuel within the pump chamber 120.

Referring generally to FIG. 5, a seal is formed between the guide tube 146 and the pump sealing member 164 when the guide tube 146 contacts the pump sealing member 164. This seal closes the opening to the central passageway 154 from the pump chamber 120. The electromagnetic force driving the armature 148 and guide tube 146 overcomes the force of springs 152 and 166, and drives the pump sealing member 164 into the pump chamber 120. This extension of the guide tube into the pump chamber 120 causes an increase in fuel pressure in the pump chamber 120 that, in turn, causes the inlet check valve assembly 156 to seat, thus stopping the flow of fuel into the pump chamber 120 and ending the charging phase. The volume of the pump chamber 120 will decrease as the guide tube 146 is driven into the pump chamber 120, further increasing pressure within the pump chamber 120 and forcing displacement of the fuel from the pump chamber 120 to the nozzle 106 through an outlet check valve assembly 170. The fuel displacement will continue as the guide tube 146 is progressively driven into the pump chamber 120.

Pressurized fuel flows from the pump chamber 120 through a passageway 172 to the outlet check valve assembly 170. The outlet check valve assembly 170 includes a valve disc 174, a spring 176 and a seat 178. The spring 176 provides a force to seat the valve disc 174 against the seat 178. Fuel flows through the outlet check valve assembly 170 when the force on the pump chamber side of the valve disc 174 produced by the rise in pressure within the pump chamber 120 is greater than the force placed on the outlet side of the valve disc 174 by the spring 176 and any residual pressure within the nozzle 106.

Once the pressure in the pump chamber 120 has risen sufficiently to open the outlet check valve assembly 170, fuel will flow from the pump chamber 120 to the nozzle 106. The nozzle 106 is comprised of a nozzle housing 180 having a central passage 182 and an outer passage(s) 184, a poppet 186 movably disposed in the central passage 182, a retainer 188, and a spring 190. The retainer 188 is attached to the poppet 186, and spring 190 applies an upward force on the retainer 188 that acts to hold the poppet 186 seated against the nozzle housing 180. A volume of fuel is retained within the nozzle 106 when the poppet 186 is seated. The pressurized fuel flowing into the nozzle 106 from the outlet check valve assembly 170 pressurizes this retained volume of fuel. The increase in fuel pressure applies a force that unseats the poppet 186. In this unseated position of the poppet 186, fuel flows through outer passage(s) 184, through a relatively large volume forward cavity, and out through the nozzle exit. The inverted cone shape of the poppet 186 creates a thin fuel sheet, such as a hollow conical sheet of fuel, which atomizes the fuel flowing from the nozzle 106 in the form of a spray (e.g., fuel spray 66). The pump-nozzle assembly 100 may be coupled to a cylinder head 192, such as the head 38 illustrated in FIG. 2, via male/female threads, a flange assembly, or any other suitable mechanical coupling. Thus, the fuel spray from the nozzle 106 may be injected directly into a cylinder.

When the drive signal or current applied to the coil 126 is removed, the drive section 102 will no longer drive the armature 148 towards alignment with the reluctance gap spacer 134, ending the discharging phase and beginning a subsequent charging phase. The spring 152 will reverse the direction of motion of the armature 148 and guide tube 146 away from the reluctance gap spacer 134. Retraction of the guide tube from the pump chamber 120 causes a drop in the pressure within the pump chamber, allowing the outlet check valve assembly 170 to seat. The poppet 186 similarly retracts and seats, and the spray of fuel into the cylinder is interrupted. Following additional retraction of the guide tube, the inlet check valve assembly 156 will unseat and fuel will flow into the pump chamber 120 from the inlet 112. Thus, the operating cycle the pump-nozzle assembly 100 returns to the condition shown in FIG. 4.

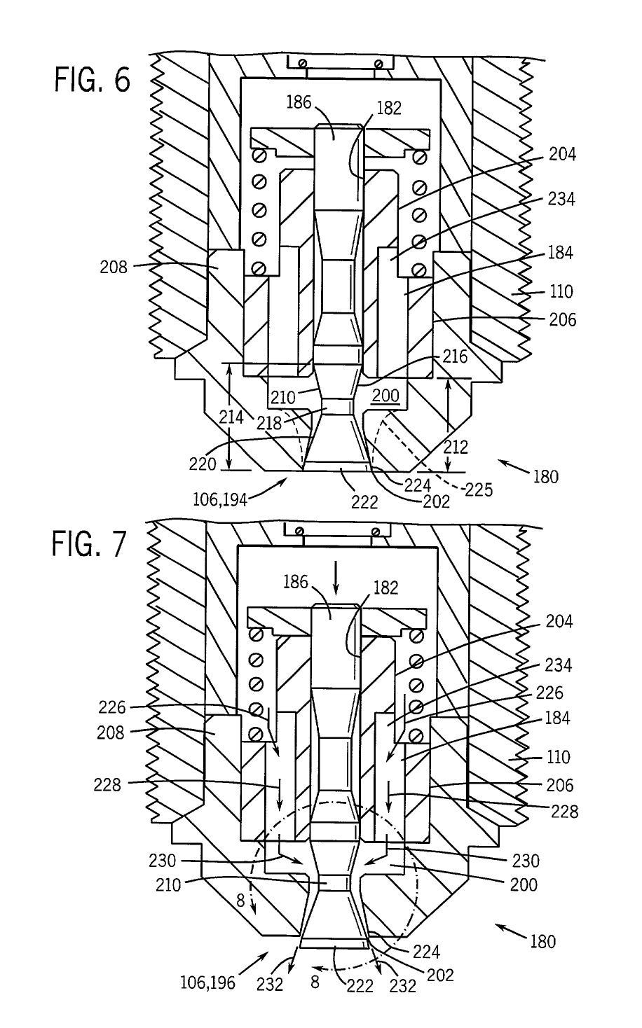

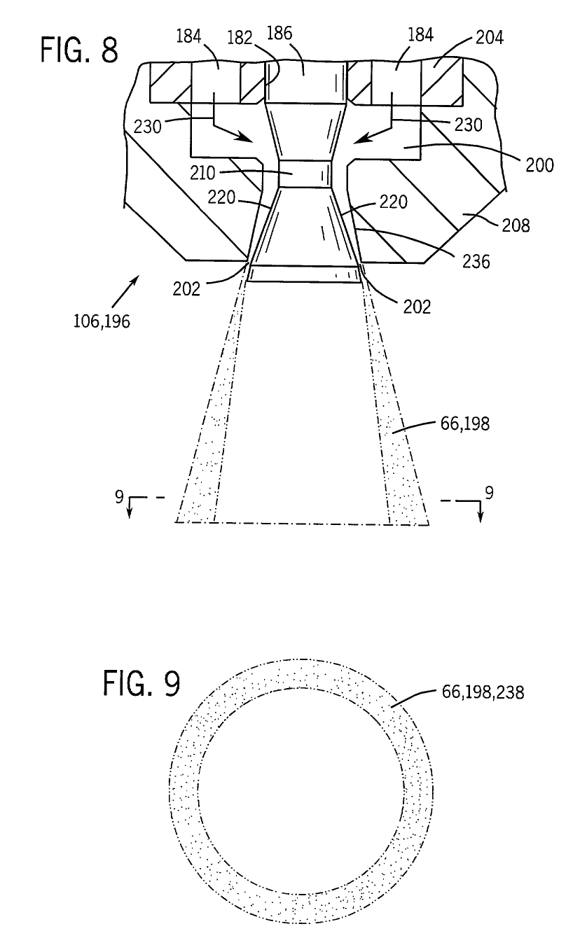

The nozzle 106 and corresponding fluid flow is illustrated in detail in FIGS. 6-9. As illustrated in FIGS. 6-8, the nozzle 106 has relatively large fluid passageways, which may advantageously dampen fluid flow variances developing upstream, slow the flow velocity through the nozzle 106, prevent formation of flow variances in the nozzle 106, and thereby homogenize the fluid flow passing through the nozzle 106. Accordingly, these relatively large fluid passageways ensure that a substantially uniform spray develops at the exit of the nozzle 106. In FIG. 6, the nozzle 106 is illustrated in a closed configuration 194. FIGS. 7 and 8 illustrate the nozzle 106 in an open configuration 196, which allows fluid to pass through the large fluid passageways to generate a hollow spray 198 having a substantially uniform cross section, such as illustrated in FIG. 9.

As illustrated in FIG. 6, the nozzle 106 has the poppet 186 movably disposed within the central passage 182 to provide flow control of the nozzle 106, while the outer passage(s) 184 feeds fluid (e.g., a desired fuel) to a forward cavity 200 adjacent an exit 202 of the nozzle 106. The central passage 182 and the outer passage(s) 184 extend through an inner section 204 of the nozzle housing 180. The inner section 204 is disposed within a rear cavity 206 of an outer section 208 of the nozzle housing 180. The forward cavity 200 is formed adjacent the rear cavity 206 between the inner section 204 and the outer section 208. The poppet 186 extends through the central passage 182 and into the forward cavity 200, such that fluid surrounds a forward portion 210 of the poppet 186 prior to exiting the nozzle 106 through the exit 202. The forward cavity 200 and the forward portion 210 have lengths 212 and 214, respectively, which are sufficiently large to slow the fluid flow, reduce or prevent the formation of fluid flow variances, and thereby homogenize the fluid flow. The forward portion 210, as illustrated in FIG. 6, has a contracting section 216 followed by a central section 218 and an expanding section 220. The expanding section is disposed adjacent a seat portion 222, which seats against a seat portion 224 of the outer section 208 in a closed orientation of the nozzle assembly. Accordingly, a relatively homogenous fluid flow is achieved by the relatively large volume of the forward cavity 200, which extends about the forward portion 210 of the poppet 186, and by the relatively large outer passage(s) 184 that feed the forward cavity 200.

The two-piece assembly of the inner and outer sections 204 and 208 also provides flexibility in the design of the flow passages (e.g., outer passage(s) 184 and the forward cavity 200) and the poppet 186. In the area leading up to forward cavity 200 (i.e., in the central passage 182), the poppet 186 may have any suitable geometry, such as a straight cylindrical geometry, one or more guide sections formed between reduced diameter sections, or any other geometry to facilitate movement of the poppet 186 through the central passage 182. Accordingly, the poppet 186 may be manufactured as a simple cylindrical needle having the forward portion 210 comprising only the expanding section 220 and seat portion 222. In contrast to conventional nozzles, the poppet 186 can be formed without flow passages in guide sections, which typically cause high flow velocities and undesirable fluid flow variations through the nozzle assembly. The forward cavity 200 also may be expanded or streamlined, such as illustrated by the expanded geometry 225 (i.e., dashed lines 225), to facilitate homogenous fluid flow and to simplify the poppet geometry for easier and cheaper manufacturing of the poppet 186.

The inner and outer sections 204 and 208 also may comprise different materials to facilitate the desired functions, durability and characteristics. For example, the inner section 204 may comprise brass or another suitable material to facilitate movement of the poppet 186 along the central passage 182, while the outer section 208 may comprise stainless steel or another suitable material to facilitate resistance to corrosion and wear due to combustion at the nozzle tip. A workable material such as brass also may improve the manufacturing of the inner section 204, which requires a substantial amount of drilling and other machining.

The outer passage(s) 184 may embody one or more passages, such as a single cylindrical passage, a single passage having a generally ring-shaped cross-section, a plurality of individual passages (e.g., 4, 6, or 8 cylindrical passages) disposed symmetrically about the central passage 182 and the poppet 186, or any suitable number, geometry and configuration of passages. In this exemplary embodiment, the fluid flows through the outer passage(s) 184 rather than through the central passage 182 about the poppet 186. Accordingly, the increased flow area through the outer passage(s) 184 eliminates the generally restricted flow passages through the central passage 182, thereby eliminating the fluid flow variances caused by the restricted flow passages. For example, the outer passage(s) 184 may have a total flow area or cross-section of approximately 30-50 times (e.g., 40:1) that of the nozzle exit, whereas the flow passages through a conventional central passage-poppet configuration may have a total flow area of only 5-10 times (e.g., 7:1) that of the nozzle exit. Accordingly, the present technique provides a substantially higher flow area upstream of the nozzle exit to slow the fluid flow, prevent fluid flow variations, and homogenize the fluid flow.

The outer passage(s) 184 feed the forward cavity 200, which further enhances the fluid flow passing through the nozzle 106. The outer passage(s) 184 may extend directly into the forward cavity 200 through a curved flow path, such as a gradual or sharp 90° angle, or the outer passage(s) 184 may extend into a ring shaped passage that feeds the forward cavity 200. For example, a desired number of the outer passage(s) 184 may extend into the ring shaped passage, which then feeds the forward cavity 200 through a desired number of linking passages that extend radially inward toward the forward cavity 200. However, any suitable configuration of feed passages, such as the outer passage(s) 184, may be used within the scope of the present technique.

The forward cavity 200 also has a volume and geometry configured to slow the fluid flow, prevent fluid flow variations, and homogenize the fluid flow. In an exemplary embodiment of the present technique, the forward cavity 200 has a volume that is sufficiently large to act as an abyss, or a stagnant fluid supply, for the fluid ejected from the nozzle 106 during each pulse of the pump-nozzle assembly 100. Although the ejected fluid volume may vary according to pulse time periods and other factors, the volume of the forward cavity 200 may be formed sufficiently large to fully supply fluid for a fluid injection pulse over a full range of operating conditions for the pump-nozzle assembly 100. Accordingly, each pulse of the pump-nozzle assembly 100 would eject all or part of the fluid in the forward cavity 200. In combination or individually, the relatively large flow areas of the outer passage(s) 184, the relatively large volume of the forward cavity 200, and the foregoing volume correlation between the forward cavity 200 and the fluid injection pulse provide a substantially homogenous fluid flow through the nozzle 106.

Exemplary fluid flows are illustrated in FIG. 7, which has the poppet 186 disposed in the open configuration 196. As illustrated, fluid flows through the nozzle 106 as indicated by arrows 226, 228, 230, 232, which correspond to fluid flows into an inlet 234 of the nozzle housing 180, through the outer passage(s) 184 of the inner section 204, into the forward cavity 200, and out of the nozzle 106 through the exit 202, respectively. As discussed above, fluid does not pass through the central passage 182. Instead, the fluid passes through the outer passage(s) 184, which has a relatively large cross section configured to reduce the velocity and homogenize the flow through the nozzle 106 to the forward cavity 200. As noted above, the outer passage(s) 184 may embody a single passage or a plurality of symmetrically arranged passages, such as 4, 6 or 8 cylindrical passages disposed symmetrically around the poppet 186 and central passage 182 in a ring-shaped pattern. The outer passage(s) 184 provide a much greater flow area than the conventional nozzle (e.g., 3:1 to 10:1), which simply passes fluid through the central passage 182 about the poppet 186. In contrast to conventional nozzles, the forward cavity 200 also has a relatively large cross-section and volume to slow and homogenize the fluid flow. Accordingly, the relatively large cross-sections and corresponding low velocities of the flows passing through the outer passage(s) 184 and the large forward cavity 200 substantially prevent the formation of fluid flow variances within the nozzle 106, substantially dampen fluid flow variances arising upstream of the nozzle 106, and homogenize the fluid flow through the nozzle 106.

These relatively large flow areas and low flow velocities also provide a relatively homogeneous hollow spray 198 (i.e., spray 66), which forms downstream of the forward cavity 200 at the exit 202 of the nozzle 106. The hollow spray 198 develops through a ring-shaped flow area, which is defined by the seat portions 222 and 224 of the poppet 186 and the forward cavity 200. As the fluid passes through this ring-shaped flow area, a thin conic-shaped sheet of the fluid disperses from the nozzle 106 and atomizes into a conic-shaped spray having a ring-shaped cross-section, as discussed below.

FIG. 8 is a detailed illustration of the forward cavity 200 and the forward portion 210 of the poppet 186. As illustrated, the fluid flow indicated by arrows 230 has a relatively uniform flow profile as it passes through the forward cavity 200 and about the forward portion 210, and outwardly toward the exit 202 between the expanding section 220 of the forward portion 210 and an expanding section 236 of the forward cavity 200. At the exit 202, the fluid flow forms the hollow spray 198 in a substantially conic spray formation, which has a substantially uniform cross-section 238, as illustrated in FIG. 9. Accordingly, the configuration and geometries of the outer passage(s) 184, the forward cavity 200, and the forward portion 210 of the poppet 186 homogenize the fluid flow and prevent the typical fluid flow variances found in conventional nozzles. The hollow spray 198 may have various geometries and dispersion rates depending on the geometries (e.g., angles of flow) of the poppet 186 and the central passage 182, as well as the fluid pressure and flow enhancement effects of the outer passage(s) 184 and the forwarding cavity 200. Accordingly, the hollow spray 198 has a relatively uniform distribution of droplets, because the fluid flows uniformly through the nozzle exit.

It also should be noted that the outer passage(s) 184, the forward cavity 200 and the forward portion 210 may have any suitable geometry to slow the fluid flow, prevent or dampen fluid flow variances, and homogenize the fluid flow adjacent the exit 202. For example, the outer passages 184 may comprise a plurality of symmetrical passages or a single passage disposed about the poppet 186 and central passage 182. The forward cavity also may have a curved profile to facilitate a more smooth flow toward the exit 202.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A nozzle comprising:
a nozzle body comprising a central passage extending through the nozzle body and a flow passage disposed about the central passage and terminating at a forward portion of the central passage; and
an outwardly opening poppet movably disposed in the central passage for controlling fluid flow through the flow passage and out through the forward portion to form a spray.

2. The nozzle of claim 1, wherein the flow passage comprises a desired geometry configured to facilitate fluid flow homogenization in the forward portion.

3. The nozzle of claim 2, wherein the desired geometry has a desired flow capacity configured to reduce fluid flow variances.

4. The nozzle of claim 2, wherein the desired geometry defines a chamber about the outwardly opening poppet in the forward portion.

5. The nozzle of claim 2, wherein the flow passage terminates symmetrically at the forward portion.

6. The nozzle of claim 5, wherein the flow passage comprises a plurality of fluid conduits.

7. The nozzle of claim 1, wherein the central passage comprises a rear portion adjacent the forward portion, the rear portion being sealingly and movably disposed about the outwardly opening poppet.

8. The nozzle of claim 1, wherein the forward portion comprises an outwardly expanding geometry.

9. The nozzle of claim 1, wherein the outwardly opening poppet comprises a depression extending symmetrically about the outwardly opening poppet within the forward portion.

10. The nozzle of claim 1, wherein the nozzle body comprises inner and outer bodies, the inner body comprising a rear portion of the central passage and a longitudinal portion of the flow passage, and the outer body comprising the forward body and a lateral portion of the flow passage extending to the forward portion.

11. The nozzle of claim 1, wherein the outwardly opening poppet is movable between open and closed orientations, the nozzle forming a ring-shaped passage between the central passage and the outwardly opening poppet in the open orientation.

12. The nozzle of claim 11, comprising a spring assembly coupled to the outwardly opening poppet for biasing the outwardly opening poppet inwardly toward the closed orientation.

13. The nozzle of claim 1, comprising a pump assembly coupled to the flow passage.

14. The nozzle of claim 13, wherein the pump assembly provides a pulsed fuel supply.

15. The nozzle of claim 1, wherein the spray comprises a substantially conical spray pattern having a substantially uniform distribution of droplets throughout a cross-section of the conic spray pattern.

16. The nozzle of claim 1, wherein the nozzle body comprises a mount structure configured for mounting the nozzle in a combustion engine.

17. A spray system, comprising:
a fluid supply assembly; and
a nozzle assembly coupled to the fluid supply assembly, comprising:
an outwardly opening poppet disposed in a central passage; and
a fluid passage terminating at a forward portion of the central passage.

18. The spray system of claim 17, wherein the fluid supply assembly comprises a pump assembly.

19. The spray system of claim 18, wherein the fluid supply assembly comprises a reciprocating drive assembly coupled to the pump assembly.

20. The spray system of claim 17, wherein the fluid passage comprises a desired geometry configured to facilitate homogenous fluid flow through the nozzle assembly.

21. The spray system of claim 20, wherein the desired geometry has a desired cross-section configured to reduce fluid velocity and prevent fluid flow variances.

22. The spray system of claim 20, wherein the desired geometry defines a chamber about the outwardly opening poppet in the forward portion.

23. The spray system of claim 20, wherein the fluid passage terminates symmetrically at the forward portion.

24. The spray system of claim 20, wherein the fluid passage comprises a plurality of conduits.

25. The spray system of claim 20, wherein the forward portion comprises a conical geometry.

26. The spray system of claim 25, wherein the outwardly opening poppet comprises a depressed portion extending symmetrically about the outwardly opening poppet in the forward portion.

27. The spray system of claim 26, wherein the nozzle assembly comprises inner and outer bodies, the inner body comprising a rear portion of the central passage and a longitudinal portion of the flow passage, and the outer body comprising the forward portion and a lateral portion of the flow passage extending to the forward portion.

28. The spray system of claim 26, wherein the outwardly opening poppet is movable between open and closed orientations, the nozzle assembly formiing a ring-shaped passage between the central passage and the outwardly opening poppet in the open orientation.

29. The spray system of claim 28, wherein a substantially uniform spray is formed from the ring-shaped passage.

30. A combustion engine, comprising:
a combustion chamber;
an ignition assembly coupled to the combustion chamber;
a nozzle assembly coupled to the combustion chamber, comprising:
an outwardly opening poppet disposed in a central passage; and
a fuel passage terminating at a forward portion of the central passage; and
a fuel delivery assembly coupled to the nozzle assembly.

31. The combustion engine of claim 30, wherein the fuel passage comprises a desired geometry configured to facilitate homogenous fluid flow through the nozzle assembly.

32. The combustion engine of claim 31, wherein the desired geometry has a desired cross-section configured to reduce fluid velocity and prevent fluid flow variances.

33. The combustion engine of claim 31, wherein the fuel passage terminates symmetrically at the forward portion.

34. The combustion engine of claim 31, wherein a substantially uniform spray is produced from a ring-shaped passage defined by the forward portion and the outwardly opening poppet in an open orientation.

35. The combustion engine of claim 30, wherein the nozzle assembly comprises inner and outer bodies, the inner body comprising a rear portion of the central passage and a longitudinal portion of the fuel passage, and the outer body comprising the forward portion and a lateral portion of the fuel passage extending to the forward portion.

36. A method for producing a spray, comprising:
moving an outwardly opening poppet within a central passage of a nozzle housing; and
providing fluid to a forward portion of the central passage through a separate passage having a geometry configured to facilitate fluid flow homogenization.

37. The method of claim 36, wherein moving the outwardly opening poppet comprises moving a head portion of the outwardly opening poppet between seated and unseated positions relative to an exit of the central passage.

38. The method of claim 37, wherein moving the outwardly opening poppet comprises reciprocally driving the head portion out of the exit and springably returning the head portion back into the exit.

39. The method of claim 37, wherein moving the head portion of the outwardly opening poppet between seated and unseated positions comprises opening and closing a ring-shaped passage between the outwardly opening poppet and the central passage.

40. The method of claim 36, wherein the separate passage has a desired cross-section configured to reduce fluid velocity and prevent fluid flow variances.

41. The method of claim 40, wherein the separate passage comprises a plurality of fluid conduits.

42. The method of claim 40, wherein the fluid comprises a fuel.

43. The method of claim 36, wherein providing fluid to the forward portion comprises feeding fluid symmetrically to the forward portion.

44. The method of claim 36, wherein providing fluid to the forward portion comprises feeding fluid to a flow homogenizing cavity disposed about the outwardly opening poppet in the forward portion.

45. The method of claim 44, wherein providing fluid to the forward portion comprises pulsing a desired volume of the fluid correlated to a cavity volume of the flow homogenizing cavity.

46. The method of claim 36, comprising pumping the fluid into the separate passage.

47. The method of claim 46, comprising pulsatingly feeding the fluid into the separate passage.

48. The method of claim 36, comprising forming a conical spray having a substantially uniform distribution of droplets throughout a cross-section of the conical spray.

49. The method of claim 48, comprising injecting the conical spray into a combustion chamber.

50. The method of claim 48, wherein injecting the conical spray comprises temporally coordinating a pulse of the conical spray with an ignition pulse produced by an ignition assembly coupled to the combustion chamber.

51. A method for forming a spray assembly, comprising:
providing a nozzle body comprising a central passage extending through the nozzle body and a fluid passage terminating at a forward portion of the central passage; and
movably disposing an outwardly opening poppet in the central passage for controlling fluid flow through the fluid passage and the forward portion.

52. The method of claim 51, wherein providing the nozzle body comprises providing an inner body having a rear portion of the central passage and a longitudinal portion of the flow passage.

53. The method of claim 52, wherein providing the nozzle body comprises providing an outer body having the forward portion and a lateral portion of the flow passage extending to the forward portion.

54. The method of claim 53, wherein providing the outer body comprises forming a cavity having rear and forward portions, the rear portion being configured to support the inner body and the forward portion being configured to define the lateral portion of the flow passage between the inner and outer bodies.

55. The method of claim 51, wherein providing the nozzle body comprises forming a multi-part nozzle body having a plurality of fluid passages terminating at the forward portion.

56. The method of claim 51, wherein providing the nozzle body comprises forming the fluid passage to terminate symmetrically about the forward portion.

57. The method of claim 51, wherein providing the nozzle body comprises forming a flow homogenizing cavity about the outwardly opening poppet in the forward portion.

58. The method of claim 51, wherein providing the nozzle body comprises forming a desired geometry for the fluid passage to facilitate fluid flow homogenization.

59. The method of claim 51, wherein movably disposing the outwardly opening poppet comprises movably disposing a head of the outwardly opening poppet between seated and unseated positions relative to an exit of the central passage.

60. The method of claim 59, comprising forming a ring-shaped passage between the central passage and the outwardly opening poppet in the unseated position.

61. The method of claim 59, comprising coupling a spring assembly to the outwardly opening poppet to bias the outwardly opening poppet inwardly toward the seated position.

62. The method of claim 51, comprising coupling a pump assembly to the fluid passage.
